(19) United States
(12) Patent Application Publication
(10) Pub. No.: US 2018/0188190 A1
(43) Pub. Date: Jul. 5, 2018

(54) SINGLE-PROJECTION PHOTON-COUNTING X-RAY QUANTITATIVE PHASE-CONTRAST MEASUREMENTS

(71) Applicant: Nikon Corporation, Tokyo (JP)

(72) Inventor: Heather L. Durko, Tucson, AZ (US)

(21) Appl. No.: 15/855,743

(22) Filed: Dec. 27, 2017

Related U.S. Application Data
(60) Provisional application No. 62/440,615, filed on Dec. 30, 2016.

(51) Int. Cl. G01N 23/041

(52) U.S. Cl. CPC G01N 23/041; G01N 2223/501

(57) ABSTRACT

An X-ray-based imaging system and related method for estimation of attenuation and/or phase-contrast and/or dark-field information representing an object between the X-ray source and the detector based on estimate of a position of absorption of a photon in a pixel within the neighborhood of pixels acquired with a single exposure of the object to X-ray beamlets. The use of a photon-counting detector devoid of a detector mask as opposed to integrating detector significantly improves performance of the system.

### CROSS-REFERENCE TO RELATED APPLICATIONS

The present application claims priority from and benefit of the U.S. Provisional Patent Application No. 62/440,615 filed on Dec. 30, 2016. The disclosure of the above-identified provisional patent application is incorporated herein by reference.

### TECHNICAL FIELD

The present invention relates to photon-counting X-ray-based imaging methodologies and, more particularly, to single-projection photon-counting x-ray quantitative phase-contrast measurements.

### BACKGROUND

There exist multiple objects the characterization of which based on the X-ray absorption under normal circumstances does not provide for good results. Among such objects there are, for example, the objects the material(s) of which have too low an X-ray mass attenuation coefficient (for example, the ratio of the atomic number-to-mass is too low), or objects in which the refractive effects at the wavelengths of X-rays dominate absorption (such as in various biological objects that may remain substantially transparent or not-opaque-enough to X-rays, for example, or objects that are too small to provide for a practically useful level of X-ray absorption).

While related art provides a solution to adapting synchrotron-based phase-contrast imaging techniques for use with conventional X-ray sources, the X-ray-based characterization continues to employ integrating detectors and is subject to multiple practical deficiencies. For example, in order to extract the phase-shift information from measurements to generate quantitative phase images of a given object, it is necessary to perform multiple projection measurements of the object, each with a different position of the X-ray blocking mask with which the integrating detector is most commonly equipped. Such multiple measurements are subject to increased error due to thermal movement, positioning errors, focal spot drift, and object motion over the course of the measurements. The multiple projections also imply an increased ionizing radiation dose to the measurement object.

Practical solutions addressing these and other shortcomings are required.

### BRIEF DESCRIPTION OF THE DRAWINGS

The invention will be more fully understood by referring to the following Detailed Description of Specific Embodiments in conjunction with the not-to scale Drawings, of which:

FIG. 1A provides a schematic illustration to a multiple-projection-based X-ray phase-contrast measurements of related art;

FIG. 1B is a diagram showing an example of a photon mask with which X-ray sources are conventionally equipped (a beamlet mask) to define a plurality of beamlets for irradiating objects during a measurements similar to that of FIG. 1A.

FIGS. 2A, 2B, 2C, and 2D illustrate projections of a given X-ray beamlet on a masked pixel of the detector unit 130 without (FIGS. 2A, 2B) and with (FIGS. 2C, 2D) an object present in the path of the X-ray;

FIG. 3A shows occurrences of absorption of X-ray photons across a pixelated detector (a photon deposits energy at pixel A; charge cloud extends to surrounding pixels to cause a signal induced at the neighborhood of pixels); FIG. 3B illustrates the image blurring caused by the acquisition of such occurrence events with the integrating detector (and resulting from the summation of individual photon absorption events over time). FIG. 3C illustrates the determination of the sub-pixel position estimate when such occurrence of events is registered with a photon-counting detector.

FIG. 4A schematically illustrates outputs of the integrating detector and the photon-counting detector (the latter—post-processing) formed as a result of absorption of photons from a beamlet (having the specified spatial profile) that is received at a given detector in absence and in presence of an object across such beamlet;

FIG. 4B illustrates a process of the sub-pixel determination of a location of a photon absorption with the use of an embodiment employing a particular type of a photon-counting detector based on an initial charge-cloud generated by a peak pixel and pixels neighboring such peak pixel;

FIG. 5 is a diagram of an embodiment of the data-collecting system for use with an embodiment of the photon-counting phase-contrast/dark-field methodology. The absence of the mask on the detector permits the entire beamlet profile to be sampled in one, single projection of the object with the use of sub-pixel position estimation techniques, and provides an added benefit of improving the dose efficiency (or signal-to-dose ratio) to the object. Relative component positions are not to scale. The dose efficiency or signal-to-dose ratio is defined as a portion of photons, in a beamlet that has passed through the object, which is acquired by the detector.

FIGS. 6A, 6B: The X-ray signal measured in photon-counting mode (shown here spanning four pixels) without (FIG. 6A) and with (FIG. 6B) the object present;

FIGS. 7 and 8, respectively, illustrate the results of simulation of mean estimated position and energy offsets for absorption events at the center of a 40-μm pixel in a 1 mm-thick CdTe detector. The position accuracy degrades the as x-rays are absorbed close to the pixel electrodes (located at z=0 μm in FIG. 7). In the case where an x-ray is absorbed about 500 μm from the pixel electrode, the energy estimated by summing the output of a 3×3 pixel region (curve A) begins to diverge from the ideal value (curve B) as photon energy increases and the charge cloud covers an area greater than the expected 9 pixels. The same phenomenon is seen to a lesser extent when the energy estimate is made by summing the values of a 5×5 pixel region (curve C).

FIGS. 9A, 9B: The simple centroid position estimation technique yields position results that fall within a circle of radius r=0.67 μm, but the absolute expected separation between two estimated points is less than expected (FIG. 9A). This is due to the known limitations of the centroid technique, which causes a distortion in the position estimates across the pixel area (FIG. 9B);

FIG. 10A: Range of percent error for the mean of N samples from a Gaussian distribution with mean M=5643.3 (corresponding to the number of electron-hole pairs generated from a 25 keV absorption in CdTe). Means calculated from 100 samples are likely to be within +/−0.5% of the actual mean. A percent error less than +/−0.1% occur with 5,000 samples; a percent error less than +/−0.05% occurs with 10,000 samples.

FIG. 10B illustrates matching of photons to beamlets. Assuming each beamlet is a Gaussian, the expectation maximization methodology is used for a Gaussian mixture model (GMM) to identify centers of beamlets.

FIG. 11A presents a plot illustrating a shift in a beamlet position (in microns) as a function of the position of the linear object positioned across the plurality of beamlets in an embodiment of the measurement system of the invention;

FIG. 11B is a plot showing the attenuation (including scatter; in units of relative intensity of X-rays passing through the rod) of the beamlet(s) as a function of the position of the linear object;

FIG. 11C is a plot showing a fraction of un-attenuated and un-scattered photons contributing to the beamlet(s) as a function of the position of the linear object;

FIG. 11D is a plot showing a fraction of original photons (in terms of relative intensity of the X-rays passing through the linear object) contributing to the beamlet passing through it.

FIGS. 12A, 12B, 12C illustrate results of a simulation of a phase-contrast measurement of a 3D object (an example: sphere) with an embodiment of the system;

FIG. 13 illustrates the comparison between the proposed methodology and conventionally-used technique(s).

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

In accordance with preferred embodiments of the present invention, methods and apparatus are disclosed for solving the operational shortcomings of current methodologies employed to collect statistically significant X-ray phase-contrast information. In particular, the problem caused by the requirement of imaging the object at multiple projections to collect sufficient quantitative x-ray phase-contrast information with integrating detection units is solved by acquisition of one single-projection image with the use of a photon-counting detector and using the sub-pixel x-ray detection information to estimate the quantitative phase shift from the statistics of the absorbed photon positions.

One problem with the use of an integrating detector for X-ray-based measurements is that, when the input X-ray beam is characterized by multiple energies, the process of integration results in loss of information of energy distribution of the input beam. For example, to reconstruct what irradiance was carried by the input beam as compared to that detected at the detector (E_{det}=−exp [−μ_{object}(E_{beamlet})x]), one needs to know the original energy distribution in the input beam. Photon-counting allows us to alleviate/go around the lack of precise knowledge of energy distribution as such information is retained: the process of photon-counting preserves an estimate of the energy deposited by each detected photon.

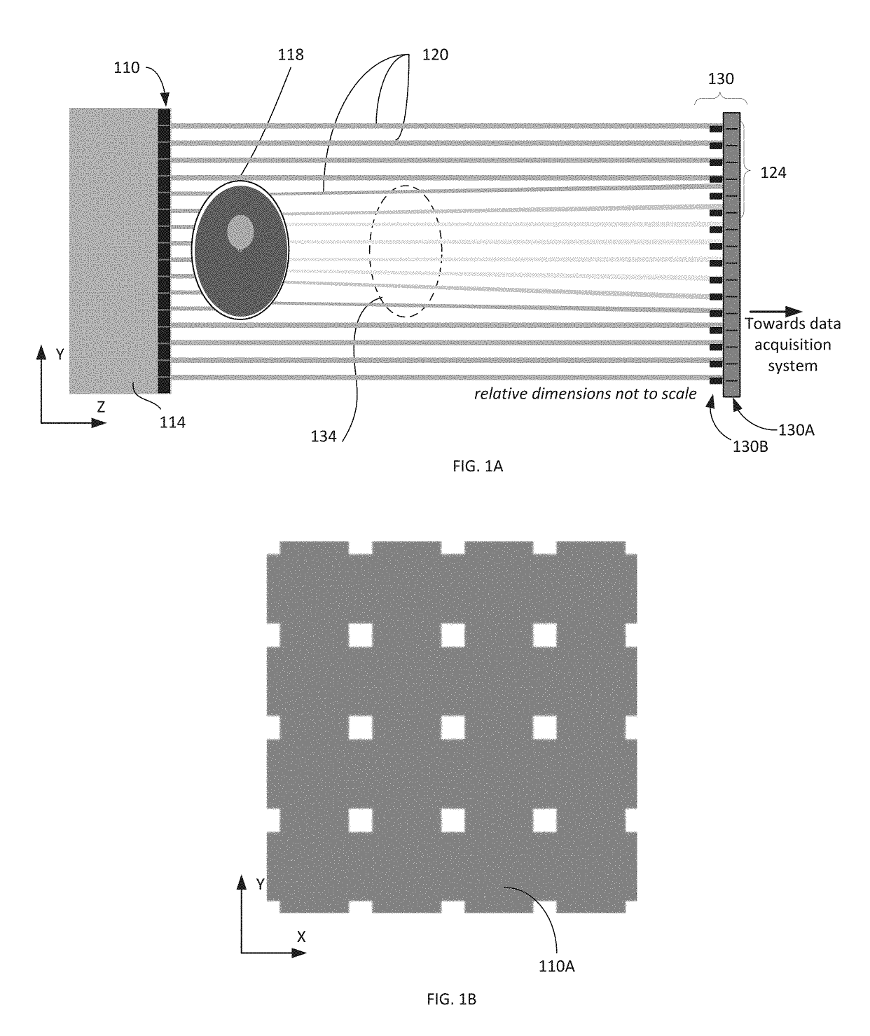

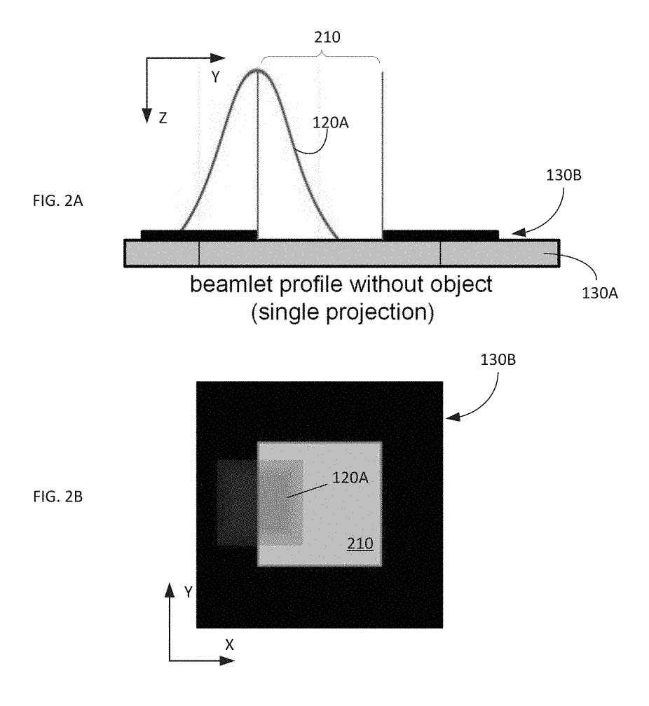

In reference to FIGS. 1A, 1B, 1C, 2A, 2B, 2C, and 2D, a conventional methodology for acquiring x-ray phase-contrast information utilizes a coded aperture or mask 110 placed between the X-ray source 114 and the object, in the path of X-ray beam, typically closer to the object (FIG. 1A) to spatially separate the produced X-ray wavefront into narrow beamlets 120 that, when no object 118 is present in the path of the beamlets 120, fall on the edge of a masked region (half open/half closed) 124 on the pixelated detector unit 130 (which includes a detector 130A and a detector mask layer 130B). Conventionally, the detector 130A is an integrating detector, and a relative phase-contrast image is being computed using the change in beamlet intensity acquired at each masked pixel of such a detector. Front views of examples of a coded aperture mask 110 are schematically shown in FIG. 1B. It is appreciated, therefore, that a beamlet represents the result of a convolution between the spatial distribution of the X-ray source and the transmission characteristic of the coded aperture mask, while the distribution of X-ray photons at the detector represents a convolution between the beamlet and the transmission characteristic of the mask (if present) on the detector. The distribution of x-ray photons at the detector is also affected by the attenuating, refracting, and scattering properties of the object along the beamlet path.

As shown in the cross-sectional diagrammatical view of FIG. 2A and in plan view of FIG. 2B, the footprint of a projection of a given beamlet 120A on the sensing surface of the integrating detector is equal to, effectively, the size of the clear aperture or opening 210 in the detector's mask layer 130B (with which the integrating detector unit 130 is necessarily equipped, to ensure that incident radiation is received by the individual pixels of the detector unit 130) convolved with the spatial cross-sectional profile of the x-ray source beamlet 120A. The coded aperture or beamlet mask 110, as well as the detector mask layer 130B (each of which can be interchangeably referred to herein as a corresponding photomask) is, generally, a plate or screen opaque for the radiative energy at a chosen wavelength (frequency) with holes or transparencies defined in it in such a fashion as to allow radiative energy to shine/penetrate through the screen in a defined spatial pattern.

The introduction of an object 118 into the path of the beamlets 120 causes specific changes in beamlets' characteristics (as indicated schematically by the dashed line 134 in FIG. 1A). In particular, at least some of the beamlets 120 are caused to experience attenuation (which reduces the beamlets' intensities), and/or scattering (which causes additional spatial/angular spreading of the beamlets), and/or a phase shift (refraction, which diverts the given beamlet 120A from its initial position on the masked detector pixel and changes its spatial profile into the profile 120, as shown schematically in FIGS. 2C, 2D).

While a relative change in beamlet position can be estimated from the relative intensity change measured from/in one projection, in order to estimate the spatial deviation and/or other spatial changes in a given beamlet 120A after refracting in or at the object 118, it is necessary to acquire X-ray intensity distributions from multiple spatial projections of the object 118. In the process of such acquisition the detector mask layer 130B, object 118, and/or the position of the x-ray source 114 are changed (for example, shifted) such that, as a result, the integrating detector 130A may end up acquiring the absorbed radiation at several, more than one, spatial distributions across the detector mask layer 130B. This process is accompanied with a number of measurement errors stemming from source 118 instability, shift of the focal spot of the X-ray source, positioning inaccuracy, and unwanted movements due to thermal effects, to name just a few. Moreover, such methodology also requires an increase in radiation dose delivered from the source 114 to the object 118 commensurate with the number of additional required projections, and, additionally or in the alternative, increases the overall time of the radiation data acquisition process.

It is understood, therefore, that while existing methodologies employ small changes in X-ray beam angle (as small as 100s of nrad) to measure changes in signal intensity across the integrating detector and permits 2D projection imaging instead of single-beam scanning, at least the following practical shortcomings continue to impede the use of such methodologies:

A) Dark-field and quantitative phase-contrast measurements are made by extracting information from multiple projection images as the coded apertures/gratings are scanned in small steps.

B) Beamlet characteristics (peak shift, beam broadening) are determined by estimating Gaussian parameters from beamlet measurements that are necessarily integrated;

C) The acquisition of multiple projections increases the amount of x-ray dose delivered to the object and the results are subject to motion blur and temporal effects; and

D) The mask layer at detector blocks part of each incident beamlet, as a result of which not all X-ray photons that can contribute to the measurement are indeed counted towards the useful measurement. (This occurs in addition to the object's attenuating the beamlet, which also leads to reduction of a “useful dose” of X-ray photons incident onto the detector.)

A related (to the conventional, admonished above, approach) X-ray tracking method was described, for example, by Vittoria et al (in Scientific Reports, 5:16318, 6 Nov. 2015), who implemented the modality for reconstruction of absorption, refraction, and scattering of the X-ray at the object without a mask layer at the face of the detector. The integrating nature of the measurement methodology, however, was remained and preserved: Vittoria used smaller pixels but still employed the integrating detector, so Vittoria's method is still subject to lower energy resolution as compared to the photon-counting method discussed here.

### Embodiments of the System and Components Thereof

The idea of the present invention stems from the realization that substitution of the integrating detection modality with a photon-counting modality permits the projection of the beamlet to be represented not as the cumulative sum of all absorptions, but as a statistical distribution of the individual absorption events, while, at the same time, using the photon-counting detector that is devoid of any associated mask layer that conventional x-ray phase-contrast detector units are equipped with.

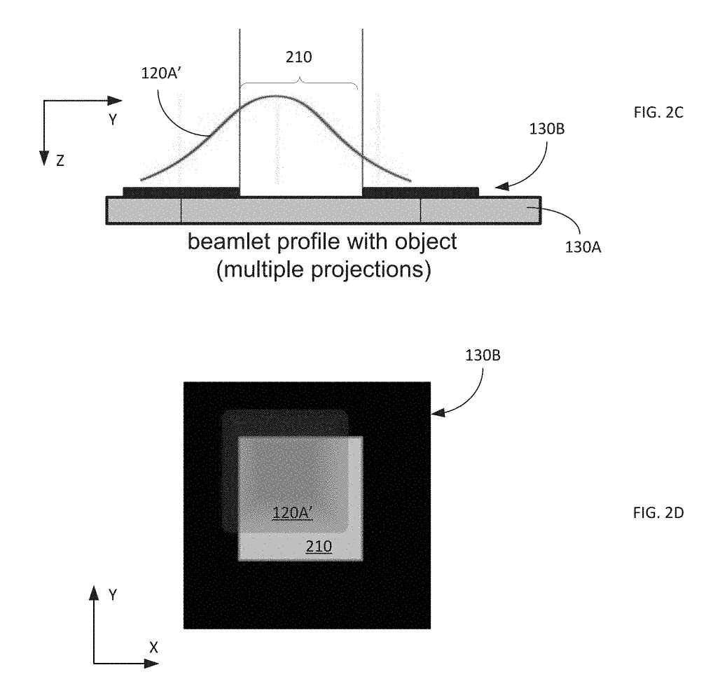

A typical integrating detector includes a thin scintillator film coupled to an amorphous silicon (aSi) detector. Each x-ray absorbed in the scintillator generates a shower of visible-light photons that in turn are absorbed in the bulk of the aSi detector bulk. In a direct-detection semiconductor detector, however, a number of high-energy electrons 304 are created in the semiconductor material of the detector 300, which electrons induce charge at the primary pixel A where the event of the absorption occurred, as well as at neighboring pixels B, C, D, E, F, and G that collect a portion of the electron cloud 310 (FIG. 3A). The density levels (˜ relative shadowing, as shown) of the neighboring pixels of the integrating detector shown in FIG. 3A schematically represent the level of the measured signal. The total amount of charge induced at the pixels overall provides a measure of the x-ray's initial energy, as shown in the right-hand-side of FIG. 3B. The spread of the photon shower appears as a blurred spot 320 that contributes signal to several detector pixels. Since these detectors are operated in an integrating mode, the resulting images suffer slightly from the combined blur of the ensemble of absorbed x rays.

In stark contradistinction with the conventional methodology, and according to the idea of the invention, the measurement of the effects of each X-ray photon as it is absorbed at a given pixel of the photon-counting detector (while information from surrounding pixels is also recorded) enables, effectuates, facilitates accurate sub-pixel position estimation and determination of the location P of the single X-ray photon absorption event, FIG. 3C, which is a simplified way (that is, neglecting the effect of calibration and/or gain corrections) can be expressed as:

$${\hat{E}}_{photon} = {\sum }_{i} {g}_{i} for pixels {g}_{i} in the region of the primary pixel \\ ( \hat{x} , \hat{y} ) = {argmax}_{x , y} ( f ( {g}_{1} , {g}_{2} , … , {g}_{N} \vert x , y ) )$$

Here, the “hat” notation refers to and implies estimate of a given value.

Photon-Counting Detector Unit. A photon-counting detector circuitry used in an embodiment preferably includes a solid-state detector that is operated at a high readout rate sufficient to visualize individual photon absorptions. Rather than employing a scintillator to convert the X-rays into secondary photons to be detected by the pixel array (as done in related art), such a detector in configured to achieve a direct conversion: the x-ray interacts directly with the bulk of the semiconductor, generating a cloud of electron-hole pairs that contribute to the detector signal. The high frame/event rate enables a new type of data acquisition in which the arrival and location of each photon is measured directly, and the distribution of charge across the pixels in the region is retained during readout, either on a full frame-by-frame or regional photon-by-photon basis. The information from multiple photon events acquired with such a detector can be combined to build up an irradiance pattern across the detector that is similar to that acquired with a standard integrating detector. Notably, this technique alone does not necessarily remove the blur due to photon and/or charge spreading (which is typical for the data acquisition with the use of an integrating detector).

One version of a photon-counting readout employs the comparison between the charge collected at each pixel and a user-defined threshold value. If the threshold is reached (implying that an x-ray has been absorbed in that region), a counter corresponding to the number of events detected at that pixel is incremented. The resulting image accumulated over time is essentially a map of integer number of photons absorbed at each pixel across the entire detector. This technique is true to the “photon-counting” moniker: no attempt is made to retain any information about the charge deposited in the semiconductor, which could be used as an estimate of each photon's energy.

Alternatively, a photon-counting detector circuitry may operate in a mode that preserves the energy information via a charge-summing. Here, circuitry in the read-out electronics of the detector unit measures the charge detected at the pixel as well as the charges collected at the neighboring pixels in the region. This signal is summed and assigned to the pixel. Assuming the frame rate is so high (or the x-ray intensity is so low) that no more than one photon arrives at each pixel in the neighborhood of surrounding pixels (causing cross-talk of deposited energies) during the frame, the “image” from the frame is a grayscale image reflecting the amount of cumulative charge associated with each absorption. This method removes the image blur associated with charge spreading (and typical for integrating detectors), providing a higher-contrast output than that of the integrating detector. Here, information about the charge is retained to a higher degree that in case of energy-binning detector. However, the resolution of the output image is still limited to the intrinsic resolution (pixel size) of the detector.

According to the idea, implemented in an embodiment, individual photon events are observed with a photon-counting detector circuitry operating in a list-mode acquisition paradigm, when the measured charge distribution in a region pixel is preserved so that each pixel represents the integration of the charge cloud over the area of the pixel. This type of detector is also sometimes referred to as a photon-processing detector to indicate that the output data has not been subject to binning or summing. The information from these measurements combined at a post-processing step can permit an accurate estimate of the exact location of the photon absorption rather than binning the position across the detector to pixel-sized regions. Such mode of operation can be implemented in, for example, two main ways: (a) when such a detector operates at such fast frame-rate in comparison with the rate at which photons arrive at the detector (or with such lower X-ray intensity incident on it) that no more than one photon may be considered to arrive at each pixel neighborhood per frame of the detector read-out; and (b) in a fashion in which a detector readout is done with respect to a given pixel at which a photon absorption has occurred and asynchronously with respect to the rest of the pixels such that the frame data is acquired without reading out the entire collection of detector pixels. The measured charge distribution in a region of pixels is preserved without any summing or binning of information and associated information loss, so that each pixel represents the integration of the charge cloud over the area of the pixel. The combined information from the measurements in post-processing can permit an accurate estimate of the exact location of the photon absorption rather than binning the position across the detector to pixel-sized regions.

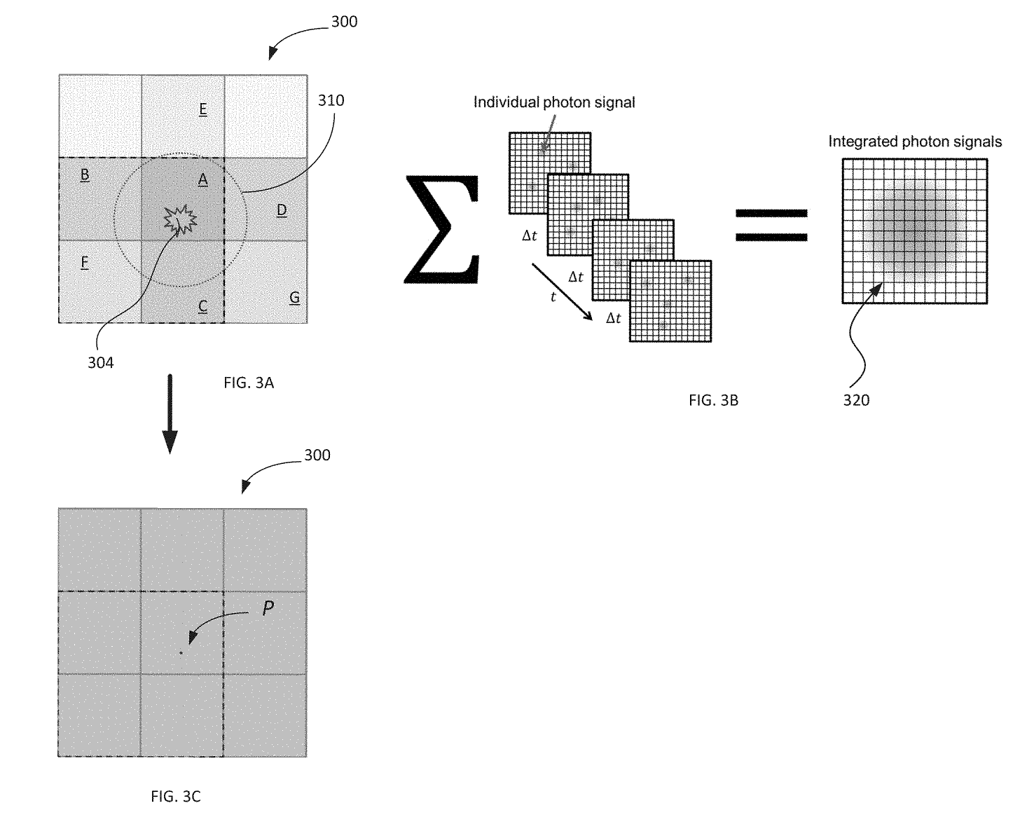

An illustrative comparison between the data output obtained from the pixelated integrating detector (typically employed in related art) and that advantageously obtained from the photon-counting detector as a result of application of the method and system of the embodiment is depicted in FIG. 4A, the sub-diagrams of which indicate the X-ray beamlet profile, the integrated output from a given pixel of an integrating detector) and statistically distinguishable photon-absorption events for a given pixel of a list-mode photon-counting detector, for two situations: with and without an object present in the path of the X-ray beamlet. Here, an interpretation of how a beamlet measurement is represented with an integrating detector and with the information collected from a list-mode photon-counting detector is depicted in the example illustration. The original beamlet falls on the intersection of four pixel comers, and the integrating detector reports four pixels of approximately equal charge value. The data from the list-mode acquisition permits a better visualization of the beamlet shape with sub-pixel resolution. When an object is inserted between the beamlet mask and the detector, attenuation weakens the beamlet intensity, refraction shifts the beamlet relative to the pixel or pixel intersections and scatter broadens the original beamlet profile. The information from the integrating detector allows us to see that the beam has been displaced from the original position but does not provide enough information to determine the relative amounts of shift, attenuation, and scatter, though these phenomena are clearly apparent in the list-mode data set.

As a complementary illustration, FIG. 4B shows the difference between the charge-summing and list-mode photon-counting detector outputs (the latter looks substantially the same as that corresponding the “charge distribution across detector pixel” portion of the image). Here, photon absorption at a given pixel generates a cloud of free charges in the detector bulk. The pixels in the region of the absorption event collect portions of the charge cloud. A charge-summing photon-counting detector integrates the charge across the set of nearby pixels and assigns the total charge to the pixel where the absorption occurred. A list-mode photon-counting detector does not sum over the pixel values and instead reports the charge of each pixel in the region as each was measured. Post-processing this data provides a more accurate estimate of the original absorption location.

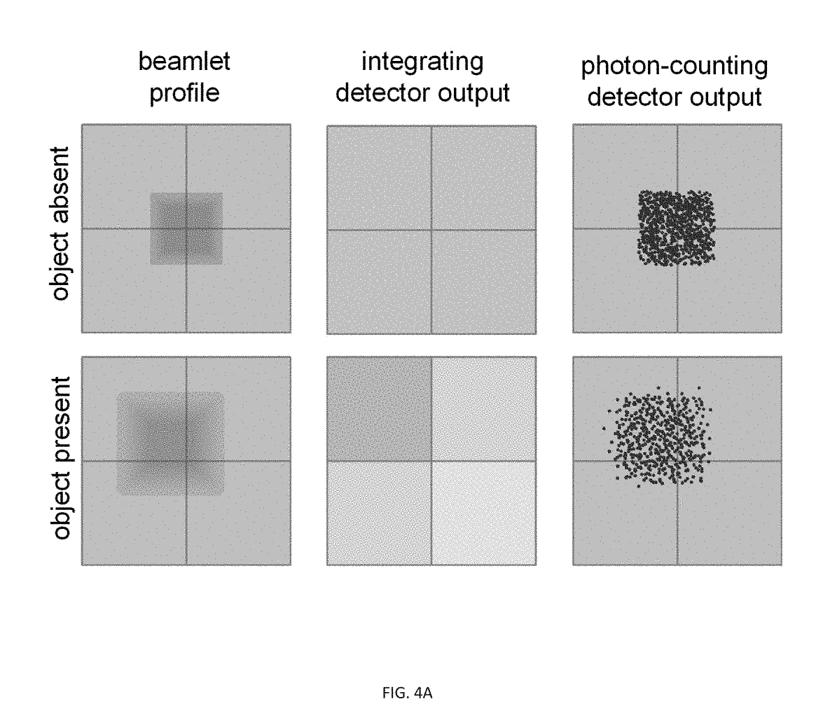

Photon-Counting Data-Acquisition System. According to the idea of the invention, the photon-counting acquisition of X-ray photons from the source 114, arriving to the detector 530A is performed with a use of a coded-aperture system that is now devoid of any detector-masking layer, in the geometry schematically illustrated in FIG. 5, and is acquired from only one single projection set of data. In comparison with a conventional data-acquisition scheme illustrated in FIG. 1A, the integrating detector is replaced with a list-mode photon-counting detector, 530A, that is devoid of a detector mask. Information corresponding to attenuation, phase changes, and scatter in the object is now extracted from estimates of the deposited energy and the statistics of each beamlet's absorbed photon distribution. The absence of the detector mask ensures that every photon that reaches the detector has an opportunity to contribute to the measured signal. This approach to phase-contrast and dark-field imaging provides data with high-resolution position and energy information from a single projection without the need for multiple exposures, moving detectors, and wasted radiation dose.

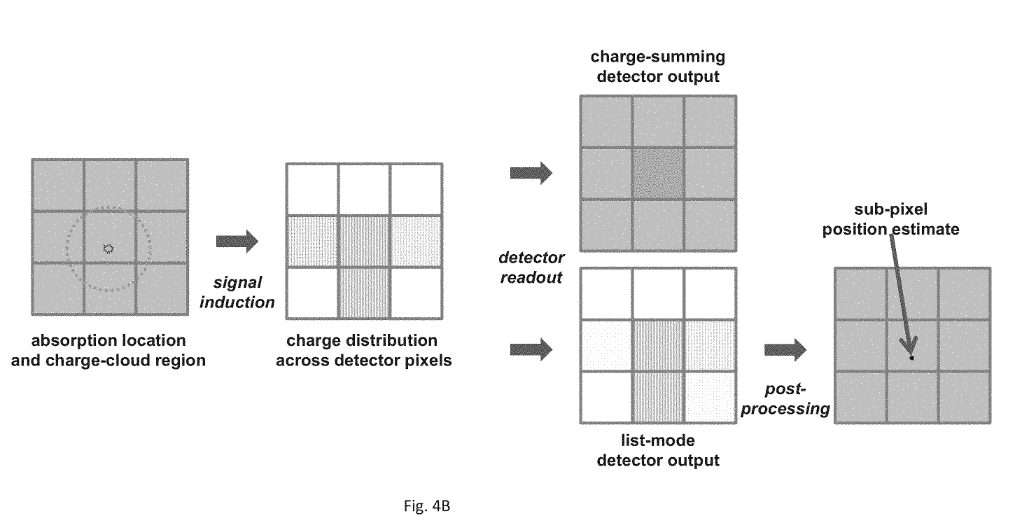

When using the proposed system, the object-free projection of the X-ray beamlet distribution provides information about the shape and distribution of the un-attenuated, un-scattered given beamlet 620A (shown as a collection of individual X-ray photons in FIG. 6A). The single, only projection acquired with the object 118 in the field of view can be interpreted as a shifted, attenuated version 620A′ of the original beamlet 620 distribution compounded with an additional distribution that represents the scattering of the X-ray photons (FIG. 6B).

### EXAMPLES OF EMBODIMENTS OF A METHOD

An embodiment of the method for determination of the location with sub-pixel accuracy generally includes the steps of: (i) estimating the spatial distribution of each beamlet directly using the data acquired by a detector (in one example, the center position x̅, y̅ and spread σ_{x,y}) from only one, single projection; (ii) acquiring X-ray data from only one, single projection with a fast, photon-counting detector to extract position, energy information for each absorption event (all measured at one detector position), such detector being devoid of any detector-surface masking layer and having its full X-ray sensing surface open to the incident beamlet(s) to cause the increased signal-to-dose ratio of radiation at the detector's surface, as compared with a method that utilizes a masked detector; (iii) identifying each beamlet from the set of beamlets incident onto the detector from a set of collected events without a need to move object and/or detector, and/or without a need to use coded apertures at the face of the X-ray source; and (iv) estimating a mean beamlet shift (refraction-cased data) and scattering profile (dark-field data) from the results/data collected at the step of identification, directly from statistics of detected photon-absorption events that have occurred in a given exposure time. The term identifying refers to and means sorting or classifying or attributing each photon to a beamlet to which such photon most likely belongs.

The simulation of X-ray propagation from the source 114 through the beamlet mask 110, through the object 118, and to the detector 530A was performed, in one implementation, with the use of a Monte-Carlo code

Example of the Simulation of Response of the Detector (Such as a Charge-Cloud Distribution in a Photon Counting Detector and Signals Induced at Primary and Neighboring Pixels).

The amount of charge collected at pixel electrodes following an x-ray absorption at the detector 530A is determined, at least in part, by the detector material and thickness, bias voltage, and electrode geometry. When an x-ray is absorbed in the detector bulk via the photoelectric effect, the photoelectron loses energy as it interacts with the atoms in the detector crystal, generating a cloud of free electrons and holes in the region of the absorption. The initial radius of this charge cloud was approximated using the continuous slowing-down approximation (CSDA, which is a measure of the total distance a photoelectron travels before it loses all its energy to the bulk crystal) for an energetic electron of the same x-ray energy. The CSDA values for an electron in CdTe were obtained from the NIST ESTAR database (available at physics.nist.gov). The assumptions were made that the generated charges were contained within a Gaussian distribution with σ₀=x_{CSDA}/10, that the electron travels in a straight line, and that over 99% of the resulting electron-hole pairs were formed within 5σ₀ of the midpoint of the Gaussian distribution. The mean number of electron-hole pairs generated in this interaction is determined by the ionization energy of the semiconductor. On average, an energy deposition of 4.43 eV generates one electron-hole pair in CdTe, so the mean number of electrons or holes generated from a photon absorption can be expressed as (neglecting partial energy deposition and scatter of energy at the detector):

$${n}_{0} = \frac{E ( eV )}{4.43} .$$

As soon as the carrier pairs are generated, the electric field from the bias voltage separates the positive and negative charges. Electrons are swept to the pixel electrode (negative bias), and holes begin to travel to the opposite side of the detector (positive bias). The rate at which the carriers travel is specified by their drift velocities vₑ=μₑε and vₕ=μₕε, where ε is the electric field across the detector thickness L, so that ε=V/L. As the carriers travel across the detector, the charge cloud expands so that at a given distance Δz from the initial generation position, the standard deviation of the Gaussian profiles are represented as

$${σ}_{e , Δ z} = {σ}_{0} + \sqrt{\frac{2 {D}_{e} Δ z}{{v}_{e}}} and {σ}_{h , Δ z } = {σ}_{0} + \sqrt{\frac{2 {D}_{h} Δ z}{{v}_{h}}} ,$$

where Dₑ and Dₕ are the diffusion coefficients of electrons and holes in CdTe. As the clouds drift towards their respective electrodes, some of the carriers become trapped due to imperfections in the semiconductor. The amount of trapping is determined by the diffusion lengths λₑ and λₕ so that after traveling a distance Δz the number of remaining carriers is

$${n}_{e , Δ z} = {n}_{0} exp ( - \frac{Δ z}{{λ}_{e}} ) and {n}_{h , Δ z} = {n}_{0} exp ( - \frac{Δ z}{{λ}_{h}} ) .$$

In the case of a pixelated detector, the signal Q induced at each pixel electrode for charges generated at location (x,y,z) in the detector was expressed as the number of electrons that reach the electrode minus a weighted sum of the trapped electrons and holes:

$$Q = q \int \int ( {n}_{e , z} + {\int }_{0}^{L} {Φ}_{w} ( r , z ) {n}_{0} [ ( 1 - exp ( - \frac{z}{{λ}_{e}} ) ) - 1 - exp ( - \frac{L - z}{{λ}_{h}} ) ] dz ] dr$$

where q is the charge of an electron and dr=dx dy implies integration over the dimensions of the pixel area. The term Φ_{W}(r,z), being the “weighting potential”, was represented as the convolution of a function representing the electrode geometry with a function representing the effective impact of charges at a given plane z from the electrode:

$${Φ}_{W} ( r , z ) = {Φ}_{0} ( x , y ) * \frac{1}{{L}^{2}} {\sum }_{n = 1}^{∞} n sin ( \frac{π nz}{L} ) {K}_{0} ( \frac{π n r}{L} ) ,$$

where K₀ is the modified Bessel function of the second kind. Simulations of the degree of charge-sharing in a specific example (which included a 1 mm-thick CdTe detector with various pixels sizes; for pixel grid or neighborhood of 5×5 pixels and 3×3 pixels) confirmed that, to be able to estimate the position of the location of the absorption of a low-energy X-ray photon on the order of 10-100 keV, the pixel size should be smaller than about 60 microns and, preferably, smaller than about 40 microns. Generally, however, the size of a pixel should be matched to the size of the charge-cloud caused by the absorption of a photon at such pixels in the neighborhood of pixels.

Examples of the Estimation of Sub Pixel Resolution: Extract Position and Energy Information from Each Measured Photon.

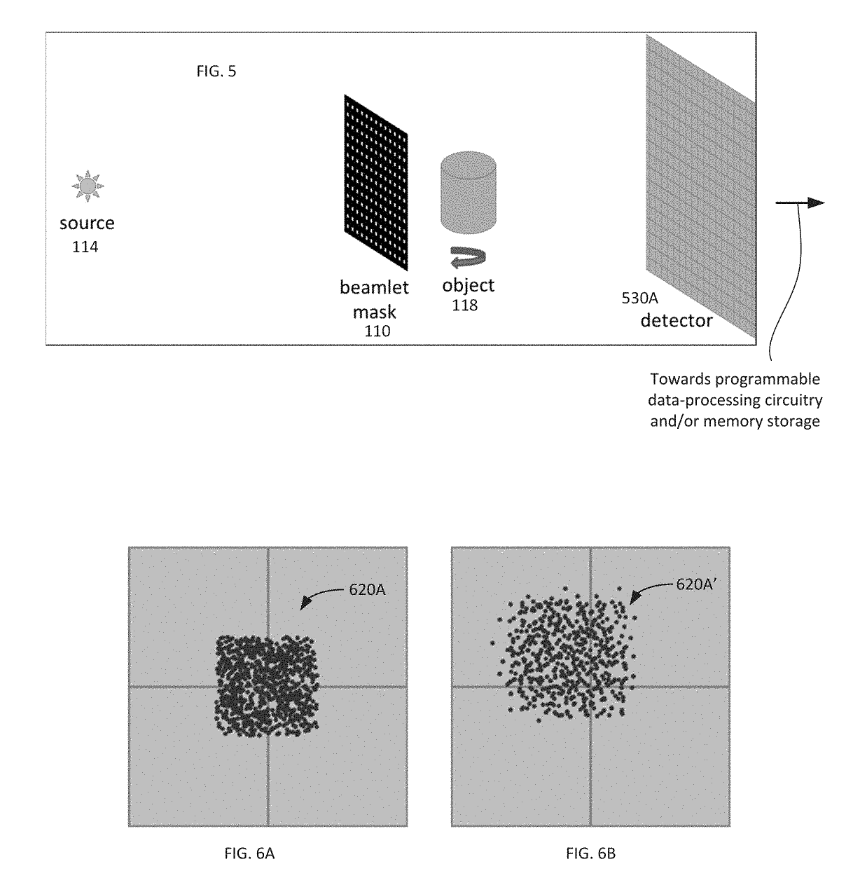

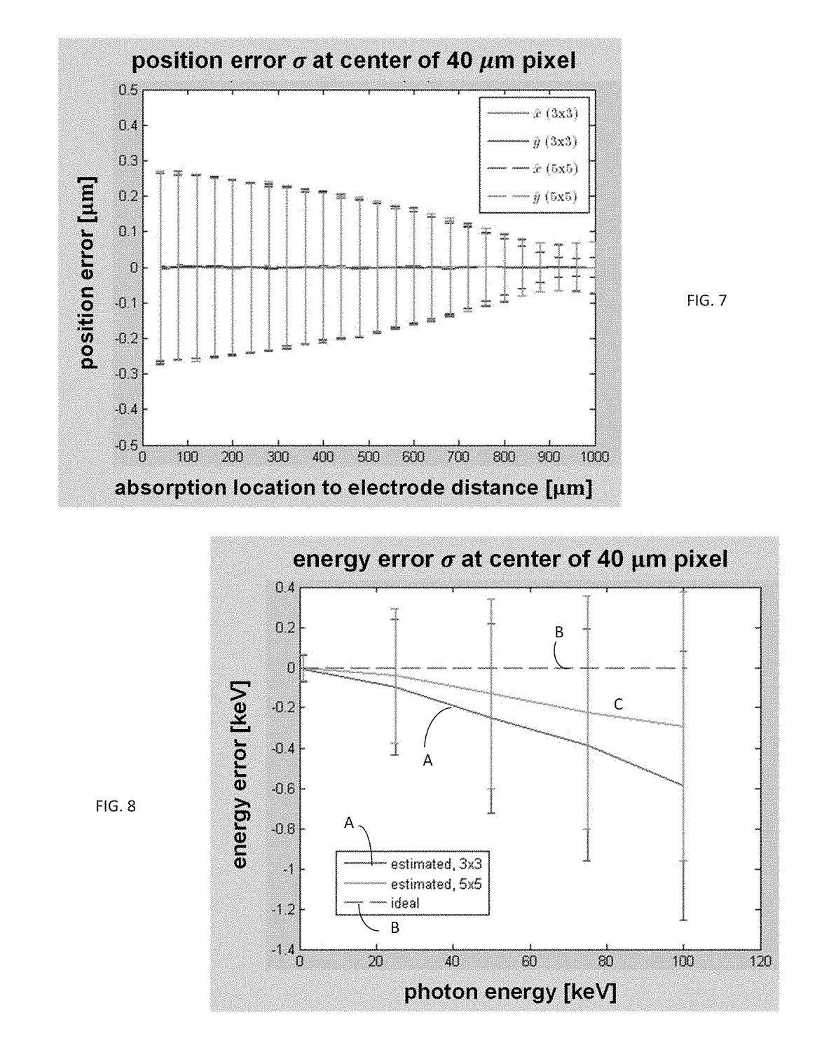

In a simplified approach, initial determination of position and energy information from each photon, detected with such detector in the list mode (performed for 10,000 noisy pixels readings corresponding to 25-keV absorption at each of 25 steps through the detector thickness z) may include the use of simple centroiding approach of position estimation for each set of N pixels:

$$\overline{x} = \frac{{Q}_{i} {x}_{i}}{N} and \overline{y} = \frac{{Q}_{i} {y}_{i}}{N}$$

where (xᵢ,yᵢ) is the position at the center of pixel i and Qᵢ is the simulated charge collected at the corresponding pixel. Estimates were performed using 3×3 and 5×5 regions of pixels. For this specific situation, pixel values were Poisson-sampled from mean charge-sharing distribution. Position estimation error (for 40 μm pixels) were determined to be σₘₐₓ<0.3 μm (when absorption occurs at least 500 μm from electrode). The results are plotted in FIG. 7: the error is lowest for absorptions far away from the pixel electrode when the charge cloud profile has more opportunity to spread across the pixel boundaries as it travels towards the electrode. Similarly, the error in energy estimation ΔE=0.6 keV, σₘₐₓ<0.8 keV was assessed for the same 40 micron pixel when a photon of varying energy was absorbed ˜500 μm or more from the pixel electrode, see FIG. 8. The decreasing accuracy as a function of energy indicates that the diameter of the charge cloud increases beyond the two considered pixel regions. To achieve adequate results from energy and subpixel position estimations, it is important to match the size of the pixel to the expected size of the charge cloud (in other words, the intended energy range of the imaging application is an essential component in selecting the appropriate detector for a practically operable system).

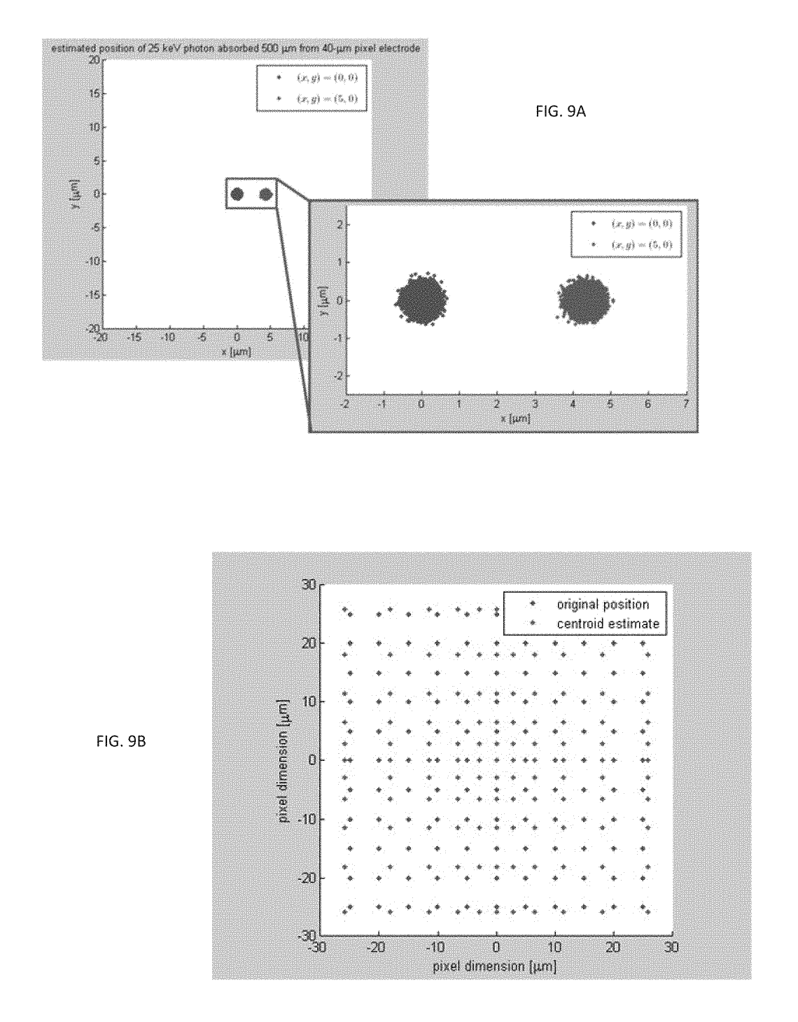

With the same data sets used to generate the plots of FIGS. 7, 8 the distribution of estimated centroid locations for 25-keV photons absorbed at (x,y,z)=(0,0,500 μm) and (0,5,500 μm) was determined, see FIG. 9A. Here, the position estimates fell within circles of radius r=0.67 μm; however, the mean position estimate for the photons at (x,y)=(0,5 μm) was off by about 0.6 μm, demonstrating the distortion effect (FIG. 9B) accompanying the use of the centroid methodology. Examples of FIGS. 9A, 9B are provided exclusively for illustration purposes, and those skilled in the art would appreciate that, in the related, preferred embodiment, the estimation of the sub-pixel absorption location is performed with the use of iterative techniques such as maximum-likelihood estimation or the contracting-grid method, for example, to achieve more uniform position estimates.

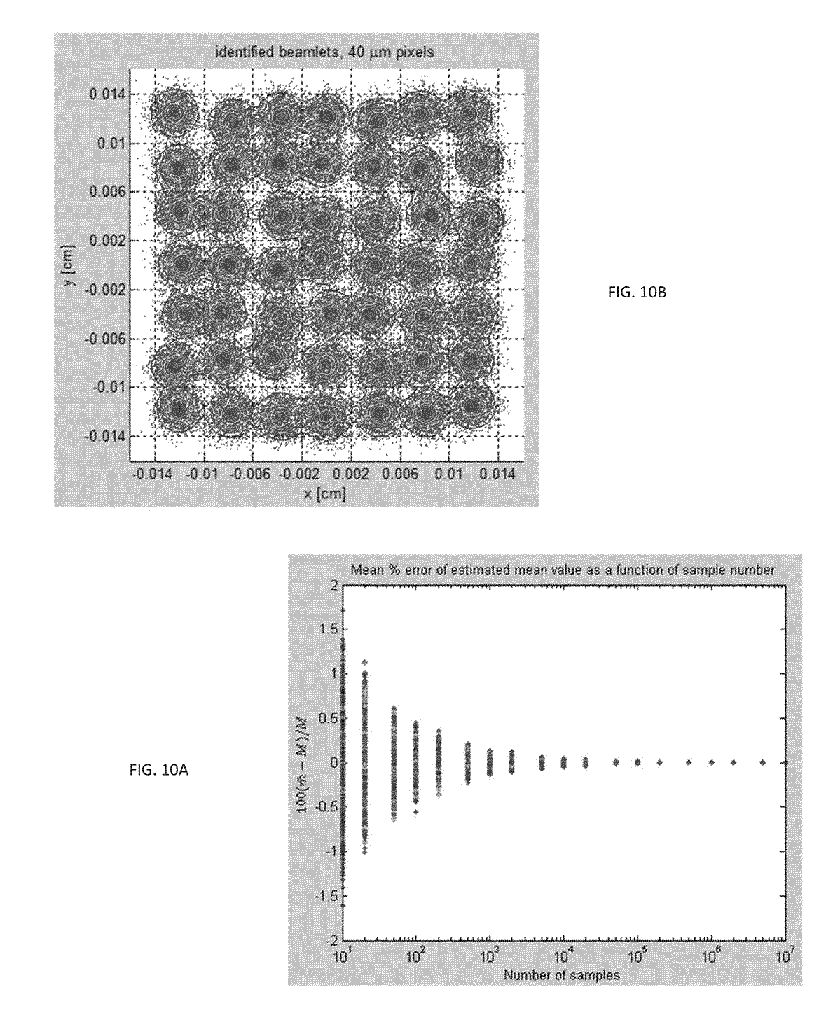

Notably, sampling of 5000 sets of N random numbers from a Gaussian distribution assuming pseudo-Poisson properties (mean and variance=M=5634.3, corresponding to the expected number of electron-hole pairs generated from a 25-keV absorption) indicated that, to achieve adequate statistical estimates of the location of the photon absorption events (defined as the mean value estimate of the position of absorption of an X-ray photon that is within +/−0.5% of the true value thereof), only about 100 samples were required. The percent error range of the estimated mean values for each set is shown in FIG. 10A. Accordingly, it was concluded that beamlets containing 5,000 photons or more would be more than sufficient to estimate the change in position due to refraction effects.

Example of an Algorithm for Extraction of Phase-Contrast and/or Dark-Field Information About the Object From a Single Projection Single Exposure) Measurement.

The data acquired from each projection image is less a grayscale image and more a scatter plot of sub-pixel photon absorption locations. In order to calculate the beamlet phase shift and spread due to scatter, it may be first necessary to identify the region corresponding to each beamlet in the measured data. This can be accomplished, in reference to FIG. 10B, in one implementation, with the use of the Gaussian mixture model (GMM) estimation.

Here, one can represent the conditional probability density of a detected photon at location x on the detector as a weighted sum of the probability densities of each beamlet b (for B total beamlets):

[symbol]

(xₙ|θ)=Σ_{b=1}^{B}π_{b} [symbol] (xₙ|μ_{b},Σ_{b})

In the above expression, μ_{b} and Σ_{b} are the mean and covariance of beamlet b, πₖ is a weighting term for each beamlet such that Σ_{b=1}^{B}π_{b}=1, and θ is a vector containing the full set of these unknown parameters (θ_{b}={π_{b},μ_{b},Σ_{b}}). The variable xₙ is the detector position (x,y) for detected photon n. One can consider π_{b} as a normalized measure of the amount of attenuation each beamlet experiences between the mask and the detector. The function [symbol] (x|μ,Σ) is the standard definition of a 2D Gaussian:

$$𝒩 ( x \vert μ , Σ ) = \frac{1}{2 π {\vert Σ \vert}^{1 / 2}} exp [ - \frac{1}{2} {( x - μ )}^{T} {Σ}^{- 1} ( x - μ ) ]$$

In order to match each photon n to its corresponding beamlet b, we can also consider a new variable z_{n ∈ {}1, . . . , B} that specifies the mixture component to which photon n belongs. The parameters in θ can be estimated by performing an iterative expectation maximum (EM) algorithm on the log-likelihood of the conditional probability function:

l(θ)=Σₙ log Σ_{z}_{ₙ}₌₁^{B} π(zₙ) [symbol] (xₙ|zₙ,μ(zₙ),Σ(zₙ))

This results in an iterative process similar to all EM algorithms:
a. Make initial guesses for all parameters in θ (i.e., all π_{b},μ_{b},Σ_{b}). In our specific case concerning groups of beamlets that deviate from their initial positions on the detector once an object is inserted into the beam, it is reasonable to assume that
   i. π_{b}⁽⁰⁾=1/B
   ii. μ_{b}⁽⁰⁾=μ_{0b} (the mean value for the beamlet measured with the object absent)
   iii. Σ_{b}⁽⁰⁾=Σ_{0b} (the original variance for the beamlet measured with the object absent)
It should be known before the routine begins the total number of beamlets B incident on the detector.
b. Compute p(zₙ|xₙ,θ^{(k)}) for each measured photon n. (The notation θ^{(k)} refers to the estimate of \hat{θ} at the k^{th} iteration. This is achieved by calculating

$$p ( {z}_{n} = b \vert {x}_{n} , {θ}^{( k )} ) = {r}_{nb} = \frac{{π}_{k} 𝒩 ( {x}_{n} \vert {μ}_{b} , {Σ}_{b} )}{{\sum }_{b} {π}_{j} 𝒩 ( {x}_{n} \vert {μ}_{j} , {Σ}_{j} )}$$

The term r_{nb} is called the “responsibility” of cluster b for data point n. For each iteration, photon n belongs to the cluster b with the highest responsibility term:

$$c . Compute {\hat{θ}}^{( k + 1 )} = arg {max}_{θ} Q ( {θ}^{( k + 1 )} , {θ}^{( k )} ) \text{:}$$

$$i . {π}_{b}^{( k + 1 )} = \frac{1}{N} {\sum }_{n} {r}_{nb}$$

$$ii . {μ}_{b}^{( k + 1 )} = \frac{{\sum }_{n} {r}_{nb} {x}_{n}}{{\sum }_{n} {r}_{nb}}$$

$$iii . {\sum }_{b}^{( k + 1 )} = \frac{{\sum }_{n} {r}_{nb} ( {x}_{n} - {μ}_{b}^{( k + 1 )} ) {( {x}_{n} - {μ}_{b}^{( k + 1 )} )}^{T}}{{\sum }_{n} {r}_{nb}}$$

d. Continue iterating until the estimates converge to a reasonable distribution of beamlets.

It is important to note that because the beamlet profiles may not be exact Gaussians, the estimates for μ_{b} and Σ_{b} may not be valid measures of the statistical properties of each beamlet. Once the beamlets have been clustered, however, it is straightforward to calculate the statistics of each mini-distribution:

$${μ}_{b} = \frac{{\sum }_{w = 1}^{{W}_{b}} {y}_{w}}{{W}_{b}}$$

$${σ}_{b} = \sqrt{\frac{1}{{W}_{b}} {\sum }_{w = 1}^{{W}_{b}} {( {y}_{w} - {μ}_{b} )}^{2}}$$

where y is the set of all photon locations xₙ for which zₙ=b, and W_{b} is the total number of photon locations in y.

### Simulation Results.

### Example 1

In a simple example, an aluminum rod with 10-mm diameter ross-section was assumed to be imaged with low-E (˜30 keV, monochromatic) X-rays in a parallel beam geometry, in which 10 μm square beamlets were separated by about 100 μm from one another, in a set-up depicted in FIG. 5 (Source-to-detector distance=2.2 m; Source-to-mask distance=1.6 m; Mask-to-object distance=0.2 m; Object-to-detector distance=0.4 m). Each beamlet was assumed to contain 10⁶ photons. Beamlets were simulated directly to remove effect of scattering at the mask and to minimize computation time.

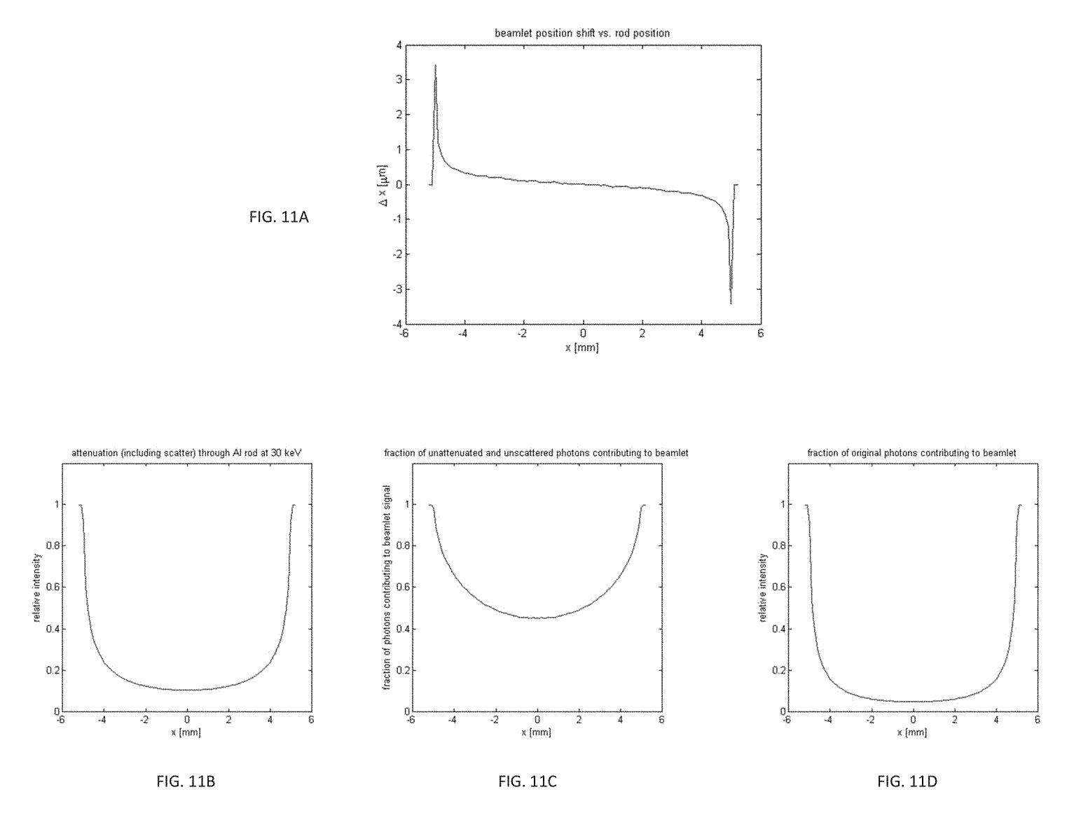

The results are shown in FIGS. 11A, 11B, 11C, and 11D, where FIG. 11A presents a plot illustrating a shift in a beamlet position (in microns) as a function of the position of the rod (in mm); FIG. 11B is a plot showing the attenuation (including scatter; in units of relative intensity of X-rays passing through the rod) as a function of the position of the rod. FIG. 11C is a plot showing a fraction of un-attenuated and un-scattered photons contributing to the beamlet as a function of the position of the rod; FIG. 11D is a plot showing a fraction of original photons (in terms of relative intensity of the X-rays passing through the rod) contributing to the beamlet, illustrating strong attenuation value.

### Example 2

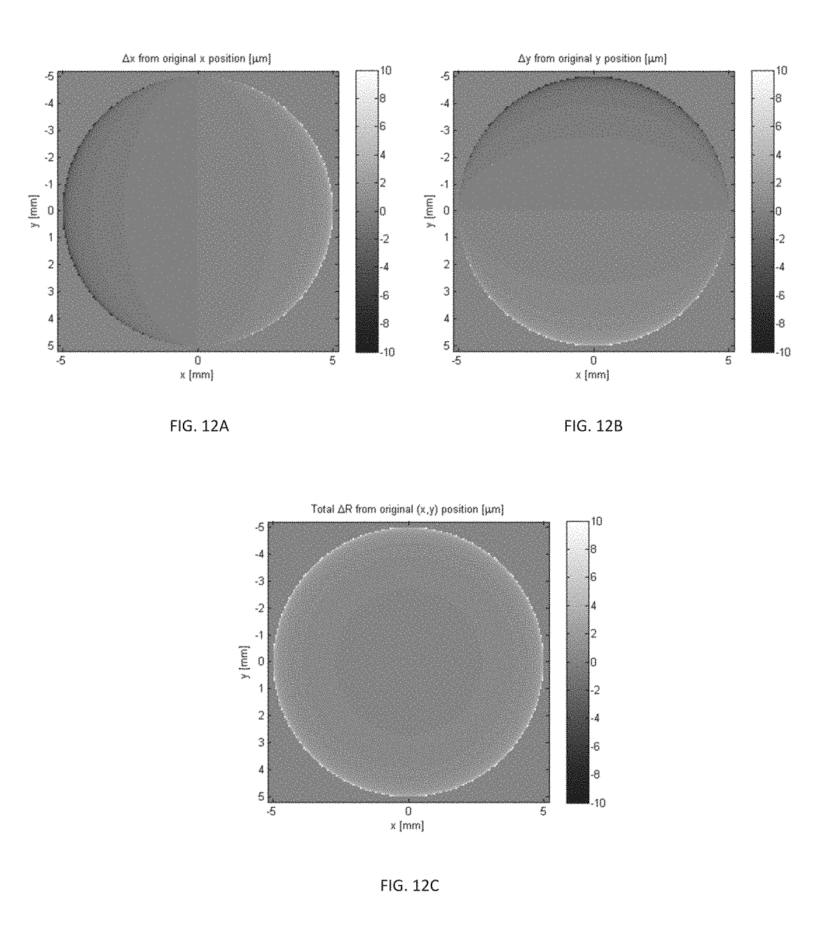

In another example, an aluminum sphere of R=5 mm simulated in FRED® to highlight simultaneous (x,y) measurement capability of the method of the invention. Here, it was assumed that the irradiating wavefront was composed of 10 μm square beamlets spaced 55 μm apart from one another. The results are presented in FIGS. 12A, 12B, 12C demonstrating that the deflection of beamlet(s) is strongly nonlinear at edge, with the minimum beamlet deviation ˜10 μm near the interface (a boundary of the sphere in this example; or interface between different materials in the sample, more generally). The term deviation, unless expressly defined otherwise, is used herein to refer to the amount of a shift of the center of photon distribution in a transverse direct (Δ(x,y)) when the object is present as compared to the situation without the object positioned in the path of the photons.

Referring again to FIG. 5, and to illustrate the test of operability of the proposed methodology, the single-exposure radiative system for use in an embodiment according to the idea of the present invention may include:

A low-energy photon source. Preferably, this would be a small x-ray source with a moderate focal spot size (on the order of 100 μm). In one implementation, a sealed radioactive source such as 125I (E ˜30 keV), 241Am (E ˜60 keV), or 109Cd (E ˜88 keV), equipped with a small pinhole aperture to simulate a weak cone beam analog, can be used.

A lithographically produced beamlet mask, for example a mask a layer of metal sufficiently thick to absorb about 99% of the incident low-energy X-rays (which, in the case of a gold mask, would amount to a mask with the thickness of about 100 microns) with a several-micron-diameter apertures spaced from one another at a known pitch distance

An energy-preserving photon-counting detector that permits the readout of pixels in the region of each photon's absorption, either through localized list-mode readout or fast frame rates that allow individual energy depositions to be visualized, and

Required mounting hardware. for the source, mask, test object and detector, as well as positioning stages to permit fine adjustment

The detector is preferably made from a semiconductor with a high atomic number to increase detection efficiency such as, for example, CdTe, Ge. Thick silicon detectors can also be used for low-energy detection applications. As demonstrated above, preferred pixel dimensions are on the order of 25-50 μm, which dimensions are small enough to permit charge-sharing across pixels for any (x,y) photon absorption, but not so small that a 5 ×5 pixel region is required to provide sufficient energy estimates. While low-energy photons are likely to be absorbed close to the entrance face of the detector, the charge cloud will be relatively small, and position estimates be more accurate if the electron cloud has an opportunity to expand as it drifts to the electrode face. For this reason, the detector should have sufficient thickness (>1 mm for a CdTe detector) to minimize errors due to poor charge spreading

In addition, the detector should be preferably configured to provide the full information about the charge collected at the primary and surrounding pixels. This can be accomplished with either a detector with a fast frame rate so that individual absorption events can be identified against a dark background, or a detector with a list-mode-type readout, i.e., one that triggers on a photon absorption and reports only those pixels in the region of the photon absorption without requiring the entire detector frame to be read out. Generally, however, a high frame rate is not necessary, provided the intensity of the source can be lessened to maintain an acceptable count rate per frame.

Overall, embodiments of the invention produce the output of a pixelated solid-state detector operated in one of several photon-counting paradigms to enable quantitative phase-contrast and dark-field measurements of an object with the single, the only exposure of the object to the chosen X-ray source. Charge-sharing effects across pixels of such a detector in the region of absorption of the radiative energy permit the user to estimate the location at which a photon was initially absorbed while, at the same time, retaining an accurate estimate of the deposited photon energy. It has been demonstrated that the sub-pixel estimation can be performed, which can effectively increase the spatial resolution of a given detector that would be comparable to that achieved as a result of the increase of the number of pixels by a factor of at least 10 (in a related embodiment—at least 100).

A basic simulation of photon-counting phase-contrast x-ray imaging from raytracing to detector response has shown that the proposed technique enables the identification of a shift of beamlets, of the radiative energy, that are as small as about 0.6 microns (for X-ray radiative energy). Moreover, the proposed methodology lends itself to being implemented within an experimental footprint of the same or even less time that would be conventionally-required for similar conventional measurement with the use of an integrating detector.

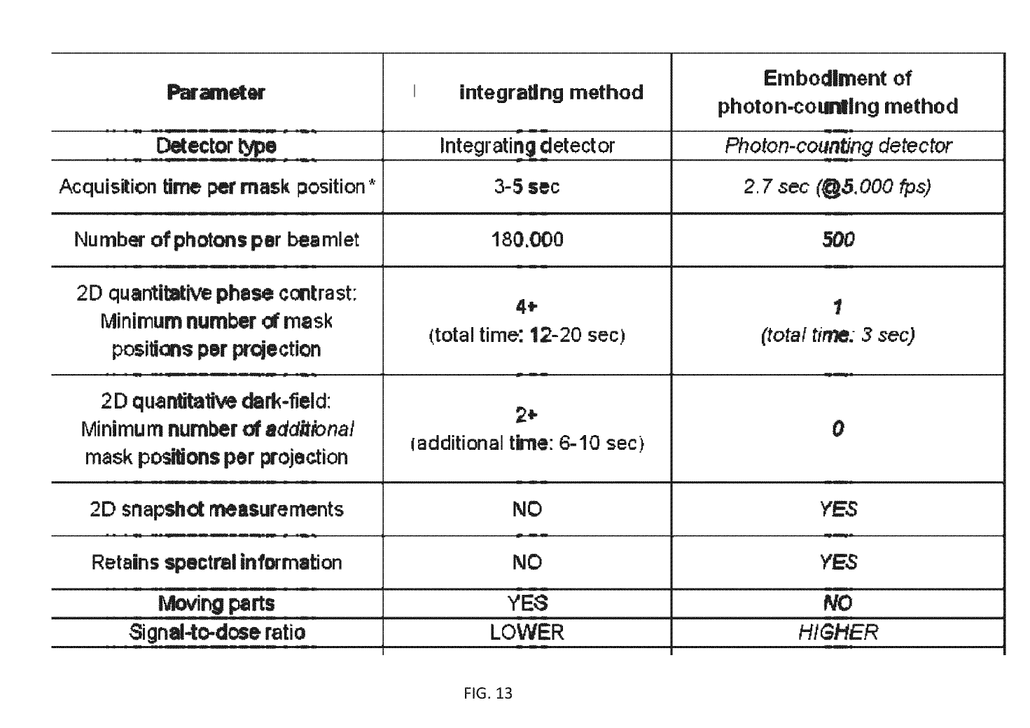

The main advantages of the proposed methodology are summarized in FIG. 13 and include the following:

Attenuation, phase-contrast, and dark-field information may be calculated from a single projection of the object (that is, a single, the only exposure of the object to the beamlets of radiative energy delivered from the X-ray source) as well as the calibration or reference projection data taken without the object being present in the field of view of the photon-counting detector. In disadvantageous contradistinction with the methodology proposed here, according to the currently-accepted and used approach quantitative phase-shift and dark-field (scatter) information must be extracted from multiple measurements acquired as the mask disposed across the path of X-ray photons is laterally shifted in the x-ray beam (which multiple measurement also have to be complemented with the calibration data). With the proposed method, the new position of the beamlet can be estimated from one measurement, reducing both the time and dose required to acquire an accurate measurement that does not require any moving parts in the employed radiative imaging system (in advantageous contradistinction with the conventional systems employed for the same purpose). The measurements can be performed without the detector mask so that the entire beamlet contributes to the measurement, minimizing the required x-ray dose delivered to the object or subject. As a result of the measurements and/or estimation of the beamlet position(s), the hardware of the overall system containing a photon-counting detector can be accordingly transformed by, for example, shifting the mask 110 (between the X-ray source and the object) or substituting this mask with a different mask possessing different geometrical characteristics such as to defined new beamlets that match the ones estimated with the proposed method.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

Embodiments of the invention may include (whether or not expressly shown in the Figures) the use of a processor controlled by instructions stored in a memory. The memory may be random access memory (RAM), read-only memory (ROM), flash memory or any other memory, or combination thereof, suitable for storing control software or other instructions and data. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Disclosed aspects, or portions of these aspects, may be combined in ways not listed above. Accordingly, the invention should not be viewed as being limited to the disclosed embodiment(s).

What is claimed is:

1. A method for determining a characteristic, representing a response of an object to interaction of the object with radiative energy, with the use of a single-exposure radiative imaging system, the method comprising:
with the use of a photon-counting detector circuitry, which contains a pixelated photon-counting detector and which is devoid of a photomask positioned to screen a portion of a surface of the pixelated photon-counting detector from radiative energy incident thereon, receiving spatially-distinct beamlets of said radiative energy to generate a detector read-out,
wherein said spatially-distinct beamlets have at least partially transmitted through the object in a single spatial projection of said radiative energy onto the detector;
generating an image, representing said single spatial projection of the object, from said detector read-out;
defining at least one of attenuation, phase-contrast, and dark-field information based on a determination of a location of absorption of a photon within a boundary of a neighborhood of pixels of said image,
wherein the at least one of (i) attenuation, (ii) phase-contrast, and (iii) dark field information represents said interaction between said radiative energy and the object positioned between a beamlet mask of the imaging system and the photon-counting detector circuitry, the beamlet mask positioned between a source of said radiative energy and the photon-counting detector circuitry configured to define said spatially-distinct beamlets,
wherein said determination is made with a sub-pixel accuracy.

2. The method according to claim 1, further comprising receiving said spatially-distinct beamlets during a process of said single spatial projection in absence of said object across the beamlets to form a reference distribution of said radiative energy at said detector.

3. The method according to claim 1, wherein said receiving is the only occurrence, of acquiring of said spatially-distinct beamlets when the object is present across the beamlets, in said method.

4. The method according to claim 1, wherein the defining includes determining said location of absorption of a photon with sub-pixel accuracy based on determining a position and energy of each photon striking the surface of the pixelated photon-counting detector with the use of centroiding operation.

5. The method according to claim 1, wherein said defining includes
with the use of a programmable processor, operably connected with the photon-counting detector circuitry, reiteratively computing a conditional probability density of a photon of said radiative energy, detected at a given location at the surface of the pixelated photon-counting detector, for each detected photon based on a vector containing initial guesses for values of mean and variance of a beamlet of said radiative energy.

6. The method according to claim 1, wherein the defining includes
with the use of a programmable processor, operably connected with the photon-counting detector circuitry, calculating a charge-cloud distribution caused by said receiving at said photon-counting detector to determine signals produced by a peak pixel the neighborhood of pixels, wherein the peak pixel is a pixel from said neighborhood that acquired largest amount of energy from photons incident thereon.

7. The method according to claim 1, wherein the defining includes
with the use of a programmable processor, operably connected with the photon-counting detector, calculating a charge-cloud distribution caused by said receiving at said photon-counting detector to determine signals produced by at least one of (i) a peak pixel in the neighborhood of pixels and (ii) other pixels in said neighborhood of pixels, wherein the peak pixels in a pixel from said neighborhood that acquired the largest amount of energy from photons incident thereon, the signals representing integration of the charge-cloud across pixel electrodes of the detector.

8. The method according to claim 7, further comprising forming said estimate based on the signals.

9. The method according to claim 8, further comprising determining sub-pixel position resolution representing absorption of photons of said beamlets by pixels of said photon-counting detector.

10. The method according to claim 1, further comprising:
transforming a distribution of said spatially-distinct beamlets in space by changing said beamlet mask to an alternative beamlet mask based on said at least one of attenuation, phase, contrast, and dark-field information.

11. A single spatial projection single-exposure radiative imaging system, comprising:
a source of radiative energy;
a beamlet mask configured to define spatially-distinct beamlets of radiative energy from a wavefront of radiative energy generated by said source and incident onto said beamlet mask;
a photon-counting detector circuitry in radiative communication with the beamlet mask, said detector circuitry containing a photon-counting pixelated detector that is devoid of a detector photomask positioned to block at least a portion of said spatially-distinct beamlets from reaching a surface of said photon-counting pixelated detector; and
a programmable data-acquisition electronic circuitry in operable communication with said photon-counting detector circuitry and a tangible non-transient data storage, said data storage containing program code which, when loaded on said programmable data-acquisition circuitry, causes the programmable data-acquisition circuitry
to generate an image, representing a single spatial projection of an object onto the pixelated detector in said spatially-distinct beamlets; and
to calculate at least one of (i) attenuation, (ii) phase-contrast, and (iii) dark-field information based, at least in part, on a determination of a location of absorption of a photon of said radiative energy within a boundary of a pixel of a neighborhood of pixels of said image;
wherein the at least one of attenuation, phase-contrast, and dark field information represents a characteristic of interaction between said radiative energy and the object positioned between the beamlet mask the photon-counting detector circuitry.

12. The imaging system according to claim 11, wherein the dark-field information represents amount of small-angle scatter of photons, of said radiative energy, formed as a result of interacting of the beamlets with the object.

13. The image system according to claim 11, wherein the image includes a single frame of a read-out from the photon-counting pixelated detector.

14. The image system according to claim 11, wherein the single projection forms multiple single frames or list-mode events of a read-out of the photon counting detector.

15. The image system according to claim 11, wherein said data storage further contains program code which, when loaded on said programmable data-acquisition circuitry, causes the programmable data-acquisition circuitry perform at least one of the following operations:
to determine said location of absorption of a photon with sub-pixel accuracy based on determining a position and energy of each photon striking the surface of the pixelated photon-counting detector;
to reiteratively compute a conditional probability density of a photon of said radiative energy, detected at a given location at the surface of the pixelated photon-counting detector, for each detected photon based on a vector containing initial guesses for values of mean and variance of a beamlet of said radiative energy; and
to calculate a charge-cloud distribution caused by receiving the radiative energy at the photon-counting pixelated detector to determine signals produced by a peak pixel the neighborhood of pixels, wherein the peak pixel is a pixel from said neighborhood that acquired largest amount of energy from photons incident thereon; and
to calculate a charge-cloud distribution caused by receiving the radiative energy at the photon-counting pixelated detector to determine signals produced by at least one of (i) a peak pixel in the neighborhood of pixels and (ii) other pixels in said neighborhood of pixels, wherein the peak pixels in a pixel from said neighborhood that acquired the largest amount of energy from photons incident thereon, the signals representing integration of the charge-cloud across pixel electrodes of the detector.
